(19) United States
(12) Patent Application Publication
(10) Pub. No.: US 2006/0071887 A1
(43) Pub. Date: Apr. 6, 2006

(54) Active matrix display and drive method thereof

(76) Inventor: CHEN-JEAN CHOU, NEW CITY, NY (US)

Correspondence Address: CHEN-JEAN CHOU, 21 RIDGEFIELD ROAD, NEW CITY, NY, 10956, US

(21) Appl. No.: 11/163,026

(22) Filed: Oct. 3, 2005

Related U.S. Application Data
(60) Provisional application No. 60/522,436, filed on Oct. 1, 2004.

(51) Int. Cl. G09G 3/32

(52) U.S. Cl. 345/82

(57) ABSTRACT

Pixel circuits and drive scheme leading to two-transistor solutions for operating active matrix light emitting device display in current-control mode are provided. Furthermore, preferred embodiment in common cathode configuration with N-channel drive transistor operated in current drive mode is provided.

### CROSS REFERENCE TO RELATED APPLICATIONS

The present application claims priority of U.S. Provisional Patent Application No. 60/522,436, filed on Oct. 1, 2004, which is hereby incorporated by reference.

### BACKGROUND OF THE INVENTION

1. Field of the Invention

The present invention relates to the pixel circuit of a light-emitting device (LED) and a drive scheme to operate such. More specifically, the present invention provides a method to address and deliver the driving power to a pixel with reduced number of elements in a pixel, thereby simplifying the structure of an LED matrix and providing improved efficiency and manufacturing economy.

2. Description of the Prior Art

Organic light emitting diode displays (OLED) have attracted significant interests in commercial application in recent years. Its excellent form factor, fast response time, lighter weight, low operating voltage, and prints-like image quality make it the ideal display devices for a wide range of application from cell phone screen to large screen TV. Passive OLED displays, with relatively low resolution, have already been integrated into commercial cell phone products. Next generation devices with higher resolution and higher performance using active matrix OLEDs are being developed. Initial introduction of active matrix OLED displays have been seen in such products as digital camera and small portable video devices. Recent demonstration of OLED displays in super large size screens further propels the development of a commercially viable active matrix OLED technology. The major challenges in achieving such a commercialization include (1) improving the material and device operating life, and (2) reducing device variation across the display area. Several methods have been suggested to address the second issue by including more active switching elements in individual pixels, by switching of power supply lines externally, or by reading back the pixel parameters combined with an external memory and adjustment circuit. As more elaborated control circuits being incorporated into individual pixels as proposed in these solutions, concerns over complexity and practical manufacturing issues arise.

The operation of an OLED display differs from a liquid crystal display (LCD) in that each and every pixel in an OLED display comprises a light emitting element. The light output of such light emitting elements is more conveniently controlled by an input current directed to the pixel. In contrast, an LCD is readily operable by voltage signals as the optical response of liquid crystal being more favorably expressed in a simple form of applied voltage. While typical storage devices hold information in the form of voltage, operating an active matrix OLED display via a typical storage element requires a conversion mechanism within a pixel to convert a stored voltage data into specific current output. In practice, a conversion method needs to be reliable and fairly independent of such factors as pixel-to-pixel variation in the characteristics of elements in a pixel that affect said conversion to make an OLED display operable with appreciable uniformity.

Basic examples of using organic material to form an LED are found in U.S. Pat. No. 5,482,896, U.S. Pat. No. 5,408,109 and U.S. Pat. No. 5,663,573, and examples of using organic light emitting diode to form active matrix display devices are found in U.S. Pat. No. 5,684,365 and U.S. Pat. No. 6,157,356, all of which are hereby incorporated by reference.

An active matrix OLED display (FIG. 1) is typically structured with “SELECT” electrodes for row select, “DATA” electrodes for setting the pixel state, power electrodes VDD to drive the pixels, and a reference voltage VREF to provide a common voltage level. A basic pixel in an active matrix display also comprises at least one transistor for data control, and at least a storage element to hold the data information sufficiently long so a pixel remains stable in a data state in an image frame between refreshing cycles. A circuit diagram for a basic pixel 100 in an active matrix OLED display is depicted in FIG. 2 in further detail. An active matrix display with pixel circuit structured as in FIG. 2 allows data to be written and retained in a storage capacitor 204 according to the data signal delivered from a data electrode in an address (or called scan or write) cycle, while the power supply VDD continuously drives OLED 205 through an n-channel transistor 201, according to the data voltage set in capacitor 204. The selection of pixels to receive data information is controlled by an n-channel transistor 203 that is controlled by the voltage on a SELECT electrode connected to the gate of transistor 203. An active matrix driving scheme allows the drive transistor 201 remain in a data state, and continue to deliver the required drive current, for an extended period of time after the input data on the data electrode is disconnected from the pixel. The peak current required for achieving a certain brightness level is thus reduced accordingly compared to a passive matrix. The peak driving current in an active matrix display does not scale with the resolution as in a passive matrix, making it suitable for high resolution applications. Stability of the active matrix display is also improved appreciably over passive displays.

As illustrated in the above example, the electrical current for producing light output is directed to the light emitting element via a current path that comprises at least a control element (201) that regulates the current. In a conventional light emitting device display, these control elements are fabricated on a thin film of amorphous silicon on glass. Power consumed in such control elements are converted to heat rather than yielding any light. For improved power efficiency by reducing such power consumption, polycrystalline silicon is preferred over amorphous silicon for its better mobility. Examples of more elaborated methods employing self-regulated multiple-stage conversions suitable for pixel circuit using polysilicon base material may be found in U.S. Pat. No. 6,501,466 and U.S. Pat. No. 6,580,408. These methods provide a current drive scheme while largely eliminated the impact from material and transistor non-uniformity typically associated with thin film polysilicon on glass base plate. In these methods, typically a minimum of four transistors are required to achieve such self-regulated, multi-stage conversion to achieve a pixel-independent current drive for the light emitting device display. An example of such methods is illustrated in FIG. 3, where four transistors 301, 302, 303, and 307, and 3 access electrodes, DATA, SELECT, and VDD, are used for each pixel with a storage capacitor 304 and an OLED 305.

The circuit in FIG. 4 illustrates another method for a self-regulating current drive scheme. The display circuit includes a switch on a power supply electrode, switching the source voltage between two voltage levels VDD1 and VDD2. Comparing to the example of FIG. 3, the transistor count of FIG. 4 is less than that of FIG. 3, while an additional access electrode to allow switching capability needs to be integrated into the array to operate the pixel and to deliver drive current to the light emitting diode in a current drive scheme.

FIG. 5 illustrates another proposed solution with an array circuit that allows external control to read the pixel parameters into an external processing circuit that comprises memory and adjustment circuitry. The variations of pixel parameters, such as the threshold voltage variation, may be offset by such external adjustment. The pixel circuit comprises five transistors and five access electrodes.

These examples of prior art provide a brief overview of the existing solutions considered in the art to resolve the uniformity issue. Comparing to the basic pixel circuit in FIG. 2, it is evident that the prior solutions to achieve uniformity in drive current involve a substantial increase in the complexity of pixel circuit, and thus likelihood of reduction of available light emitting area, efficiency, and production yield.

It is also evident from these examples that in a conventional pixel circuit, a scan electrode primarily operates to control the high-impedance input gate of a control transistor in the pixel of an active matrix display.

The present invention provides a data setting circuit that connects a data electrode and a scan electrode, and conducts the input data current between the two. A scan electrode in the present invention operates as a multi-functional scan electrode for pixel access that performs the conventional pixel select function and provides a conversion function for converting a data current to a data voltage. The present invention further provides multiple conducting channels in a pixel, for setting the data voltage and delivering drive current. The pixel structure so constructed comprises a direct current path from a data electrode to a scan electrode, and may further comprise a direct current path from a scan-power electrode to the light emitting element. The turning-on and off of such channels are fully controlled by the voltage applied to a scan electrode.

### SUMMARY OF THE INVENTION

In an active matrix display, data information is delivered to the pixels of the display in a data setting period. Such data setting period for a pixel is controlled by applying a scan voltage to the scan electrode that turns on a gating circuit in the pixel to allow data information to enter said pixel. A conventional gating circuit is a gating transistor, such as the transistor 203 illustrated in FIG. 2, which is turned on by a scan voltage on the select (scan) electrode, and wherein the scan electrode provides no further communication with the pixel beyond the gate of transistor 203.

The present invention provides a pixel circuit in an active matrix display with a data setting circuit connecting a data electrode and a scan electrode. Said data setting circuit conducts a data current directed from a data electrode to a scan electrode during a data setting period. Furthermore, said data setting circuit sets (writes) a data voltage to a storage element according to the data information. More specifically, the data setting circuit in the present invention comprises a diode. The diode is set in forward bias to conduct a data current during a scanning (data setting) period when data information is delivered to said pixel and written to said storage element. The present invention further provides methods to operate such pixel circuit.

Furthermore, a voltage referencing circuit and drive method are provided to operate an active element, such as a transistor, in a data setting period in such a manner that one end of said storage element in the pixel is connected to a reference voltage for setting data via this active element that is configured in reverse direction of its configuration in other period of time. Such operation provides a fixed data reference voltage to said storage element in a data setting period during which a data voltage is set to the storage element, while releasing the storage element from such voltage constraint in other period of operation.

Preferred embodiments of said voltage referencing circuit comprising a transistor which alternately also operates as a drive transistor regulating a drive current directed to a light emitting element in the pixel are provided.

The present invention further provides preferred embodiments of pixel circuits and a drive method, within which a scan electrode further operates to deliver a full drive current to a light emitting device in the pixel. Such a multi-functional scan electrode is different from a conventional scan electrode which performs a narrower function of selecting pixels for data input. Such multi-functional scan electrode is herein referred to as scan-power electrode.

As a preferred embodiment of the present invention, the data setting circuit between a data electrode and a scan electrode is structured to convert a data current directed thereto to a data voltage. Such data voltage sets the voltage of the storage element in the pixel. Such a stored data voltage controls a drive current to the light emitting element in a pixel. Preferred embodiments are provided for the data setting circuit comprising a data setting transistor which generates said data voltage at the gate terminal of the data setting transistor.

Preferred embodiments and drive methods of the present invention are provided to illustrate applications of such pixel circuits and drive method in current drive scheme for light emitting device display.

Preferred embodiments of the present invention are provided for the operation of a display in current drive scheme to eliminate dependency on threshold voltage variation and OLED characteristics. Preferred embodiments in three-transistor implementation are provided to illustrate the application to the solutions for current drive scheme for light emitting device display. Furthermore, current drive scheme is demonstrated in common cathode, n-channel transistor drive configuration.

The present invention provides pixel circuits and a drive method to operate said pixel circuits, where a pixel comprises a conducting channel between a data electrode and a scanning electrode; the enabling and inhibiting of such conducting channel are fully operated by the control signal voltages applied to the scan electrode.

The present invention provides a display comprising at least a pixel, a data electrode, and a scan electrode. The pixel comprises at least a data setting transistor and a capacitor comprising two ends. Said data setting transistor generates a data voltage and sets one end of the storage element to this data voltage during a data setting period when a scan signal is applied to a scan electrode; wherein said scan electrode further sets the voltage of the other end of the capacitor to the same level as said scan electrode during said data setting period.

Further application of the present invention includes the driver circuit for LED backlight used in LCD displays, which presents a similar requirement for uniformity as for an matrix light emitting device display.

Additional features and advantages of the present invention will be set forth in the description which follows, or may be learned by practice of the invention. The objectives and other advantages of the invention will be realized and attained by the structure particularly pointed out in the written description and claims hereof as well as the drawings.

### BRIEF DESCRIPTION OF THE DRAWINGS

FIG. 1 is a schematic of a prior art active matrix light emitting device display.

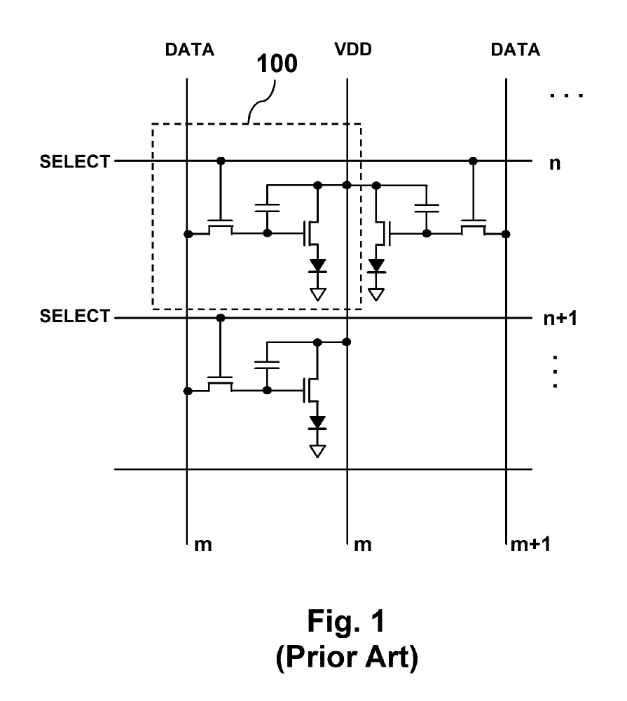

FIG. 2 is a schematic of a prior art pixel circuit in an active matrix light emitting device.

FIG. 3 is a schematic of a prior art pixel circuit in an active matrix light emitting device.

FIG. 4 is a schematic of a prior art pixel circuit in an active matrix light emitting device.

FIG. 5 is a schematic of a prior art pixel circuit in an active matrix light emitting device.

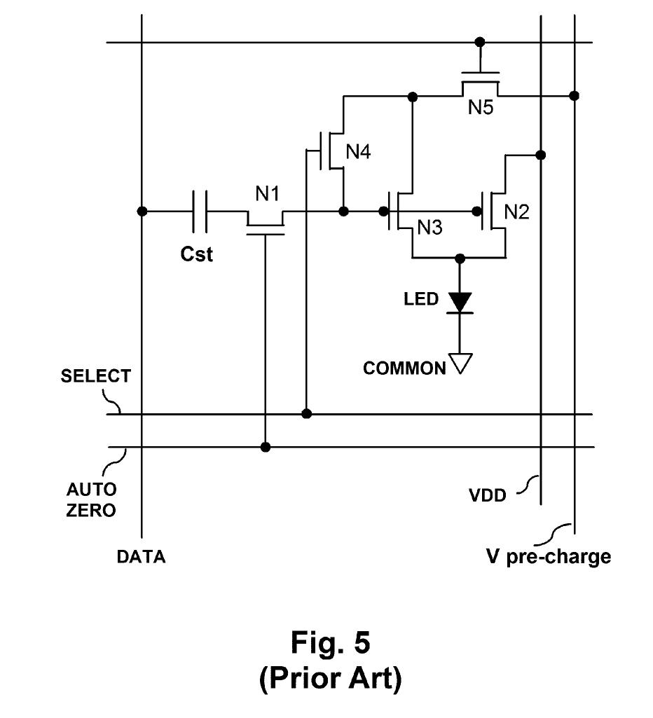

FIG. 6 is a schematic diagram of a preferred embodiment of a data setting circuitry in the present invention.

FIG. 7 is a diagram representing a preferred embodiment of a referencing circuitry in the present invention, illustrating a voltage referencing of a storage capacitor.

FIG. 8 is a schematic diagram of a pixel circuit in a preferred embodiment of the present invention.

FIG. 9 is a schematic diagram of a pixel circuit in a preferred embodiment of the present invention.

FIG. 10 is a schematic diagram of a pixel circuit in a preferred embodiment of the present invention, applying to a general light emitting device.

FIG. 11 is a schematic diagram of a preferred embodiment of a pixel circuit of the present invention, applying to a switching reference source.

FIG. 12 is a schematic diagram of a preferred embodiment of a control circuit in a pixel of the present invention.

### DETAILED DESCRIPTION OF THE INVENTION

The present invention is directed to the operation of light emitting devices. Preferred embodiments and respective claims are described in light of the application to active matrix light emitting device displays.

Preferred embodiments of the present invention are herein described using organic light emitting diodes as illustration. Examples of using organic material to form an LED are found in U.S. Pat. No. 5,482,896 and U.S. Pat. No. 5,408,109, and examples of using organic light emitting diode to form active matrix display devices are found in U.S. Pat. No. 5,684,365 and U.S. Pat. No. 6,157,356, all of which are hereby incorporated by reference.

In this specification, voltages and potentials in an embodiment are referenced to a reference voltage level VREF in that embodiment. The meaning of voltage and potential are thus interchangeable within each respective case. Claimed subjects follow the same descriptive convention.

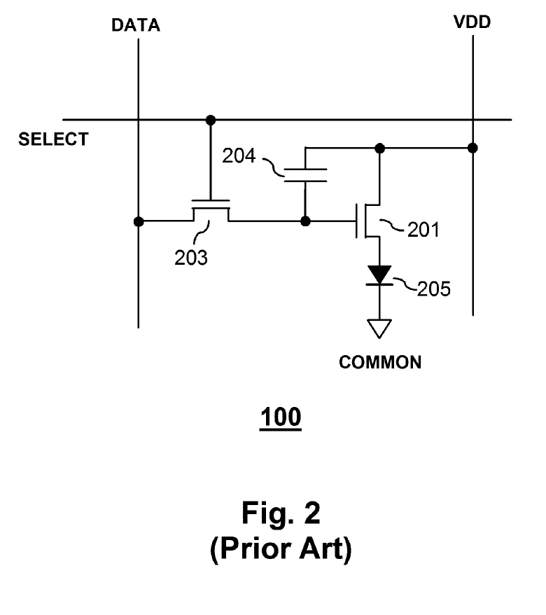

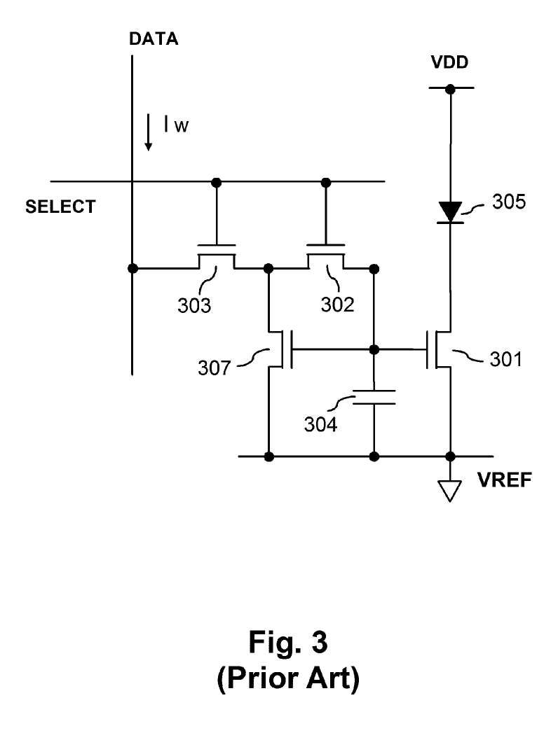

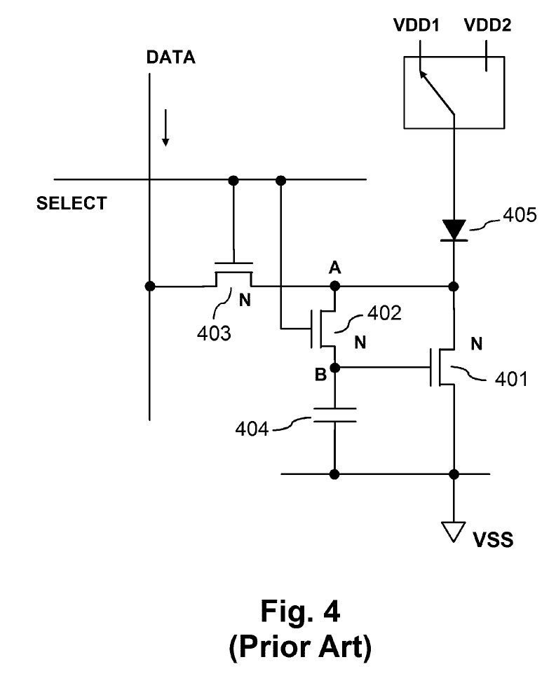

As evidenced in the prior art illustrated in FIG. 2 to FIG. 4, the conventional method of constructing and operating an active matrix display involves a scanning electrode (or referred to as SELECT electrode, GATE electrode, or other names carrying similar meaning) and a power supply electrode (VDD). Such conventional scanning electrode operates to deliver switching signals to the gates of transistors in a pixel to turn said transistors on and off. In the prior art, one end of a storage element that holds a data voltage in a pixel is connected to the gate of a drive transistor and the other end is either connected to a reference voltage that does not adjust its voltage to the circuit operation such as illustrated in FIG. 2 to FIG. 4, or is not referenced to any fixed voltage level in all operation periods of a display.

The present invention provides a data setting circuit in a pixel circuits that connects a data electrode and a scan electrode. Such data setting circuit conducts a current directed from a data electrode and a scan electrode. Such data setting circuit is controlled according to a signal voltage applied to the scan electrode. Said data setting circuit is further arranged to provide a conversion function to convert a data current to a data voltage, and to set an internal storage element to said data voltage. Specifically, said data setting circuit comprises a diode, wherein said diode is forward biased to conduct said data current.

The present invention further provides a voltage referencing circuit comprising an active element, such as a MOS transistor, and a method to operate such that in a data setting period, one end of a storage element in a pixel is connected to a reference voltage via this active element that is configured in reverse direction of its configuration in other time. Such operation provides a fixed reference voltage to said storage element in a data setting period during which a data voltage is set to the storage element, while releasing the storage element from such voltage constraint in other period of operation.

The present invention provides active matrix pixel circuits and a method to drive such. The circuit comprises a conducting channel between a data electrode and a scan electrode. Enabling and inhibiting of said conducting channel is controlled by the signal applied to the scan electrode.

The present invention further combines with a scan-power electrode that operates to deliver drive power via a scan electrode. The same electrode that selects a pixel for data input delivers a full amount of drive current in a subsequent operating period. A pixel so constructed utilizes a scan-power electrode that delivers drive current while inhibiting data transfer between said data electrode and said pixel in one period, and enables data input from data electrode into said pixel according a scanning signal in another period.

In this specification, a scan electrode represents an access electrode that performs a scanning (or select) operation. A scan-power electrode further emphasizes an access electrode that is structured to perform both a scanning operation where a scanning signal is delivered to enable data input in selected pixels in a data setting period, and a drive operation where a drive current is delivered to a light emitting device in another period of operation. A scanning (or data setting or write) cycle is a period that a pixel is selected to allow data to be transferred from a data electrode to the selected pixel. The transferred data information is stored in a storage element in the pixel thereafter until the next scanning period.

In the description of this invention, a direct current path is a conducting path capable of conducting an end-to-end current continuously, wherein such current is not interrupted by or ended on a capacitor; it may comprise such elements as resistor, drain-to-source and emitter-to-collector conducting channel of a transistor, anode-to-cathode path of a diode, and conductive lines, which allow a current to continue. Specifically, a capacitor with a current directed toward it charges to a terminal voltage and terminates the current after that point, and thus disrupt the continuity of said current after its being charged up to the terminal voltage. A direct current path in this description further implies that it is enabled and conducts intended operating current in at least one of the operation periods for operating a display device. A charging current ended on or via a capacitor does not constitute a direct current path. Transient currents arising from charging of input gate or parasitic capacitors are not considered as providing valid current path. The reverse leakage of a diode, the leakage current in a transistor in its off-state, and current via the high impedance input terminals (such as a base or a gate) are also not considered as valid current paths. Accordingly, a direct current path in this specification provides a specific conduction of intended pixel current responding to the input signal for the purpose of operating said pixel, and comprises elements listed above with specific restrictions described thereinafter.

In this specification, an active element comprises a high-impedance control terminal and a current channel between a second terminal and a third terminal, wherein the control terminal controls the current between the second and the third terminals. In operation, a control signal is applied to said high-impedance control terminal to regulates the current directed along said second and third terminals. The high impedance control terminal is briefly referred to as a “gate” in this specification, which includes the gate of an MOS, and the base of a bipolar transistor. Referencing to a gate of an active element in this specification should not be construed as narrowing the scope of a general active element comprising MOS, bipolar transistor, JFET, and alike which operate equally well under a similar operating principle. An MOS transistors having a gate as the control terminal, and two other terminals arranged as source and drain are used as illustration in the preferred embodiments as an active element in this description. For those skilled in the art, it is well recognized that all such similar devices as bipolar transistor and JFET, operate equally well as an active element in this description and in respective claims.

An organic light emitting diode (OLED) is used in most preferred embodiments wherever appropriate; the presence of such a device in such embodiments should not be construed as setting forth a limitation on the present invention directed for light emitting devices in general. MOS devices are used in preferred embodiments for switching elements. Similar bipolar transistors will perform similar functions as MOS devices. Those skilled in the art can quickly derive variations by a substitution of an arbitrary light emitting device for the organic light emitting diode, or by different types and polarities of switching devices. Preferred operating condition and preferred input data format do not necessitate limitations on the operation of the present invention.

A storage element includes one or a combination of a capacitor structure and parasitic capacitors.

Preferred embodiments of the present invention are provided for the current drive scheme to eliminate dependency on threshold voltage variation and OLED characteristics. Preferred embodiments in three transistor implementation are provided to illustrate the solutions for current drive scheme within the present invention.

The present invention comprises a combination of two features in a pixel circuit: (1) conducting channel between a data electrode and a scan electrode that generates and sets a data voltage to a storage capacitor from a data current, and (2) a drive transistor that reverse its source and drain in a data setting period to set one end of said storage capacitor to the voltage of a scan electrode. This method provides a solution to construct a common-cathode pixel while using an n-channel drive transistor in current control mode.

The present invention may also be viewed as a pixel circuit comprising a data setting circuit connecting a data electrode and a scan electrode, wherein said data setting circuit generates and sets a data voltage to a storage capacitor from a data current, in conjunction with feature (2) described hereinabove.

Preferred embodiments of the present invention will hereinafter be described in detail with reference to the drawings.

The present invention provides drive methods and circuits that allow active matrix light emitting device to be operated in current-control mode that provides sufficient offset to the variation of pixel elements and result in pixel-independent current control. Specifically, the present invention provides two-transistor solutions to achieve such current control operation. These solutions are by far the least complicated in circuit and driving scheme, and offers improved manufacturability.

The present invention utilizes the following techniques: (1) providing current path between data electrode and scanning electrode, and using such current path to convert current value to voltage, (2) devising a scheme and a data setting circuit element which result in a reversal of source and drain of a data setting transistor between scan cycle and drive cycle, (3) reversing referencing the storage capacitor to the voltage of the scan electrode via the drive transistor during a data setting period, and (4) replacing a via transistor with a diode in the current path of (1), and adjust voltage range to inhibit data influence from data electrode in a drive cycle. New and more effective circuit configurations are thus created.

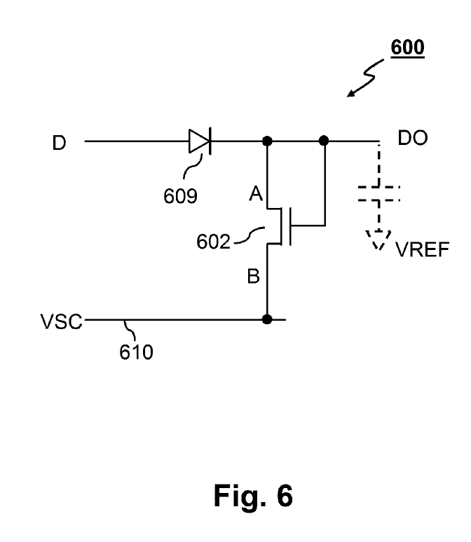

The drive scheme provided in the present invention is described with a preferred embodiment of a data setting circuit provided in FIG. 6 comprising a transistor 602 and a diode 609. One of the two source-drain terminals, terminal A, of 602 is connected to the gate of 602, and the other terminal (B) is connected to a control voltage VSC. A diode 609 is attached to the A-terminal of 602. The other end D of the diode is connected to the input data electrode. Such a data setting circuit may be embedded in a pixel with additional elements attached to it, such as a storage capacitor and a drive transistor.

The preferred embodiment represented by circuit 600 provides A current path between VSC and D, via diode 609 and the two terminals that are the source and drain terminals of transistor 602. More specifically, the data setting circuit 600 connecting a data electrode D and a scan electrode VSC comprises a diode 609 arranged in series with the second terminal and the third terminal of transistor 602.

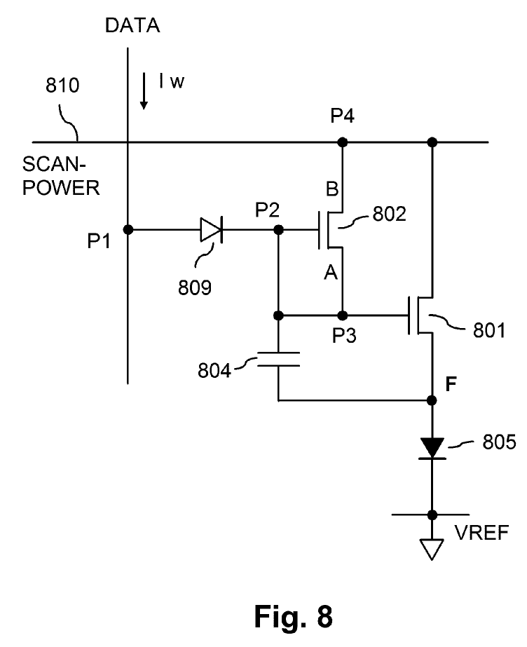

As described in detail below in the operation for FIG. 6 and for FIG. 8, the source and drain configuration of transistor 602 is determined by the relative potential between D node and VSC node. Such configuration reverses between different operation periods. As the source and drain terminals are not statically configured, but rather dynamically dependent on the applied voltage on VSC (or the scan-power electrode in FIG. 8), these two terminals are referred to as the second and third terminals of a transistor for the purpose of specifying connections to other elements in the description and in the claims.

In a more specific implementation, 602 may be assigned an n-channel transistor, and the cathode of diode 609 is connected to the A-terminal of 602. Terminals A and B of n-channel transistor 602 operate as source and drain, respectively, when VSC is more positive than DO, or drain and source, if otherwise. Referring to such an implementation, when the potential of VSC is substantially lower than D (by more than the onset voltages of 609) and DO, diode 609 is set in forward bias, making A-terminal more positive than B. This condition sets A and B the drain and source of n-channel transistor 602, respectively, and gives V_{GS}=V_{DS} as the gate is short to the drain. This condition further allows the potential at DO to be determined by a current flow from D to VSC according to the saturation condition of transistor 602, where the transistor current ID is in proportion to (V_{G}-V_{TH})², where V_{G} and V_{TH} are the voltage at the gate and the threshold voltage of the transistor, respectively. When VSC is set high and more positive than DO, A-terminal of n-channel transistor 602 operates as a source and B-terminal a drain, giving V_{GS}=0, since the gate of 602 is now short to the source. The transistor 602 is thus in a high impedance state. During this time when VSC is more positive than DO, the state of DO will then be determined by the relative potential between DO and D: If DO is more positive than D, diode 609 is in reverse bias, leaving DO in a high impedance state and inhibiting the influence from D on DO. If D is more positive than DO, diode 609 is in forward bias, permitting signals on D to interfere with DO. An operating condition thus has to be adjusted to ensure that DO is more positive than D when the state of DO needs to be maintained and not to be interfered by external signals of D. If DO is connected through a capacitor to a reference voltage VREF, as is often constructed in many applications, such an adjustment may be achieved by controlling the reference voltage VREF in a manner that DO is raise to a more positive potential than D or to a level that current from D to DO is inhibited in a non-writing cycle. Noted here is that the reference voltage VREF for capacitor may be a dynamically varying voltage level in a pixel operation that provides a fixed reference voltage only in a period when it is desirable.

According to the description above for the embodiment of FIG. 6, a current is directed from the data electrode D to the scan electrode “VSC” via 602, in a period when VSC is set negative relative to D. The data setting transistor 602 converts such a current to a data voltage at the node DO, according to a saturation operating condition of the transistor characteristic.

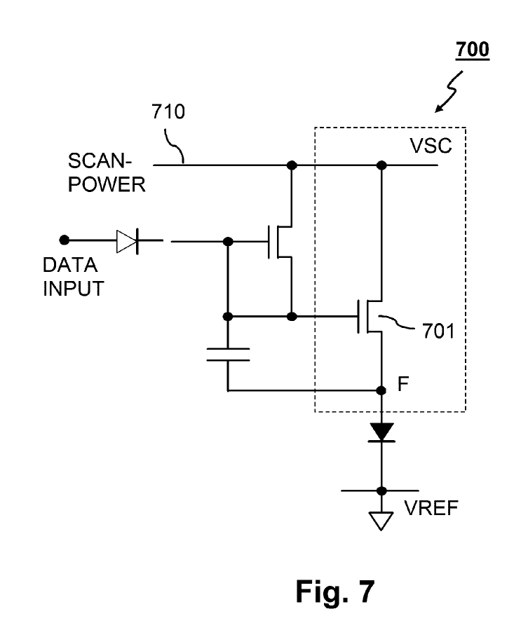

In addition to the data setting circuit described in the preferred embodiment of FIG. 6, the present invention further provides a pre-determined fixed voltage reference to the capacitor for data setting in a scanning cycle, whereas the capacitor's connection provides a voltage level that is adjusted to the drive condition in a drive cycle rather than to a fixed level. Such a dynamic referencing scheme, as opposed to a fixed voltage connection for all operating periods, is illustrated in a preferred embodiment in FIG. 7. In a drive cycle, point F is not provided with a fixed voltage level. The voltage at node F is the source voltage of transistor 701 that is adjusted to conform to the circuit operating condition according to the drive current in 701, the gate voltage of 701, and the characteristic of the drive transistor 701. In a data setting period, the scan-power electrode 710 is switched from a drive voltage to a scanning voltage that is set to be the lowest voltage level in this circuit to reverse the direction of the source and drain of transistor 701 and to inhibit any drive current beyond node F as the voltage of node F is set low by VSC via 701. Said scanning voltage also set diode 709 in forward bias, allowing data signal to reach the gate of transistor 701. Any positive data value then turns on transistor 701 and resets the point F to the same voltage as said scanning voltage of scan electrode VSC via 701.

FIG. 8 provides an example of a preferred embodiment of a pixel circuit in the present invention utilizing the methods and circuit elements described above. In FIG. 8, 802 and 809 are the equivalent of 602 and 609, 801 is the equivalent of 701, and 804 is a storage capacitor. The cathode of diode 809 is connected to the gate and to the second terminal of transistor 802. The first end of storage capacitor 804 is connected to the gate and the second terminal of transistor 802, and to the gate of transistor 801 to retain data information for regulating the drive current of OLED 805. The second end of capacitor 805 is connected to the second terminal of transistor 801. The cathode of OLED 805 is connected to a common reference voltage source VREF. In this embodiment, transistors 801 and 802 are assigned to be n-channel transistors.

In a preferred operation, the control voltage applied to scan-power electrode 810 alternates between V_{LO} and V_{HI}, where V_{LO} enables the pixel for data writing (scanning cycle) and V_{HI} disengage the pixel from data electrode and provides drive power (drive cycle). The level of V_{LO} should be set well below the onset voltage of OLED to prevent any voltage increase in 801 due to branch current in 805 in a scanning period. In addition, V_{LO} should be equal to or slightly below the lowest data voltage to provide a reliable reference for data registry. Such a choice in V_{LO} further sets diode 809 in forward bias in a data setting period. The minimum dynamic range from V_{LO} to V_{HI}, and the difference between V_{HI} and VREF, both should be greater than the sum of the dynamic range of data input and the maximum forward voltage of OLED 805, to prevent data saturation. Taking polymer light emitting diode as an example (for 805), a typical forward voltage drop for active matrix application would be within 5V. A dynamic data range of 3V may be programmed for data format. An additional 1 V may be allocated for data driver to compensate the voltage drops at the diode 809 and at the transistor 801. A preferred voltage for V_{HI} is thus about 9V above V_{LO} and VREF. To maintain high data integrity during drive cycles, VREF should be adjusted to be at or slightly above the highest data voltage afforded on the data electrode. For example, if data range is 0 to 3V, VREF should be set at or slightly above 3V. Similar operation settings can be derived for small molecule OLED, and other types of light emitting devices from their respective characteristics.

An alternative to the above preferred operation condition is to adopt a slightly compromised method that operates on a smaller voltage range, thereby reducing the requirement on power supply and the stress from reverse voltage on devices in their off-state. In this method, VREF is shifted lower by a voltage, at which the light emitting device remains well below its onset. For a polymer LED, this voltage is approximately 2V; for a small molecule OLED, this voltage is approximately 4V. By doing so, the total voltage amplitude of a scanning electrode is reduced by the same amount. Using the example of a polymer LED from the previous paragraph, such a compromised operating conduction provides a preferred setting of 1 V for VREF, 10V for V_{HI}, and 0V for V_{LO}. There is a trade off for this comprised method. The dark state of a pixel may generate off-state current (and thus light) when subsequent data voltage is in the upper range. Slight accumulation of positive voltage can take place as diode 809 is not in reverse bias and the data voltage will be divided between diode 809 and OLED 805, causing a low level conduction below the onset of 805. The net effect is thus a reduced contrast ratio and increased loading effect on the data driver.

In a preferred operation, data information is formatted in a form of current source I_{W}. With reference to the circuit of FIG. 8, and with the aforementioned preferred operating conditions, a preferred operation of said circuit is described in detail hereinafter:

1. Data signal and desired output. A typical OLED produces a light output proportional to its current. Such proportionality is generally represented in a linear approximation for most applications. For example, to display an image in 64 levels of gray scales, each increment in the gray scale corresponds to 1/(64−1) of the maximum current that corresponds to the full brightness level. A linear gradation of brightness in an image is thus represented by a linear gradation of input current accordingly. In order to maintain a uniform control of light output across a large area of a display without significant detriment due to the variation from pixel to pixel, it is preferable to devise a pixel circuit and an operation scheme that convert input data signal linearly into output current on OLED. Such a conversion scheme is preferably to be independent of variations of major parameters in a pixel circuit, such as threshold voltage of the control transistors and OLED forward voltage. It is recognized in the art that such a site-independent conversion may be better accomplished by using data signals in the form of current source, as illustrated in prior art. Accordingly, the discussion here focuses on the operation using current source I_{W} delivered on a data electrode to produce a current output ID on an OLED. In this regards, in a preferred format, data information is formatted in the form of a data current, where the data current is proportional to the brightness of the corresponding data point of the information to be displayed. In the subsequent illustration, preferred circuit embodiments and its operation are provided to produce an output current in a drive cycle that is converted linearly from the input data current in a scan cycle. Such preferred operation in current control mode should not be construed as a limitation of the present invention.

2. Scanning (data writing) cycle. A voltage low signal V_{LO} is applied to a scan-power electrode 810, setting the B-terminal of n-channel transistor 802 at the lowest level, making A-terminal a drain, and setting forward biasing the diode 809 in forward bias if any positive data current is directed toward the pixel. Regardless of the data value to be registered, this action of setting B-terminal to V_{LO} ensures that any excess voltage stored in the capacitor 804 from a previous cycle that would cause a reverse biasing on the diode 809 can be properly discharged, since this residual positive voltage is acting on the gate of 801, and is on the drain and gate of 802, keeping both transistors in a conducting state. As input data current I_{W} is directed toward the gates of n-channel transistors 802 and 801 and capacitor 804, any non-zero current will accumulate positive charge (and voltage) on the gates of 802 and 801, turning on both transistors, as discussed above for 600 and 700. As transistor 801 is turned on, floating point F is thus reset to V_{LO} as a fixed reference level for capacitor 804. The data information is therefore properly registered into capacitor 804 with reference to V_{LO}. On transistor 802, a positive voltage on the gate and A-terminal sets A-terminal a drain and B-terminal a source, as discussed above for 600. Transistor 802 then has a configuration of drain-to-gate short, and provides
V_{GS2}=V_{DS2} (1)

where V_{GS2} is the gate-to-source voltage of transistor 802, and V_{DS2} is the drain-to-source voltage drop on 802.

According to the characteristics of MOS transistors, the condition given in Eq. (1) ensures that 802 is at the onset of saturation, and the current (ID) through 802 is control by the gate voltage according to a formula:
I_{D2}=C₂(V_{GS2}−V_{TH2})² (2)

where V_{TH2} is the threshold voltage of 802, and C₂ is a constant determined by the width, length, and intrinsic parameters such as the mobility of silicon, the thickness and dielectric constant of the gate oxide of transistor 802. Approaching the end of a scan cycle, the current branched into the capacitor 804 diminishes to zero, and the entire data current I_{W} is channeled through transistor 802, thereby giving
I_{D2}=I_{W} (3)

It should be noted that the voltage drop V_{C} on capacitor 804 is the same as V_{GS2}, V_{GS2}=V_{C}, since the line voltage on 810 is at the same level as VREF in a scanning cycle.

3. Drive cycle. After data is written into a pixel and the capacitor 804 charged to a voltage V_{C}=V_{GS2} that sets transistor 802 in saturation region, electrode 810 is pulled to a voltage high (V_{HI}) sufficient to provide a full forward bias on OLED 805, and to keep transistor 801 in its saturation region. A preferred voltage high (V_{HI}) is typically equal to, or higher than the sum of the maximum OLED forward operating voltage and the dynamic data range of input data. Such a condition for V_{HI} ensures that the drain-to-source voltage drop V_{DS1} of transistor 801, in a drive cycle, is higher than the stored voltage V_{C} in the capacitor 804 written in a scan cycle, thereby forcing transistor 801 into its saturation region. As line voltage of 810 being set at a more positive level than A-terminal of 802, transistor 802 is set in a high impedance state as its gate is at the same potential as the source, as described above in the discussion related to FIG. 6. At the same time, drive current is enabled, raising the voltage at the anode of OLED 805 to its forward voltage, and elevate the capacitor voltage at A-terminal well above the maximum data voltage. This ensures a reverse bias on diode 809. With the transistor 802 in a high impedance state and diode 809 is reverse bias, the data information stored at capacitor 804 is properly retained.

With the conditions provided above for V_{HI}, and an I-V analysis of operating conditions of transistor 801, it can be verified that V_{DS}≧V_{GS} in a drive cycle. The transistor 801 therefore remains in the saturation region, and ID is given by a similar formula as above:
I_{D1}=C₁(V_{GS1}−V_{TH1})² (4)

where I_{D1} is the current through 801, C₁ is a constant determined by the width, length, and intrinsic parameters such as the mobility of silicon, the thickness and dielectric constant of the gate oxide of transistor 801, and V_{GS1} is the gate-to-source voltage of transistor 801 in a drive cycle, noting that V_{GS1}=V_{C}=V_{GS2}.

Given the close proximity between 801 and 802, all the intrinsic parameters and the thickness of oxide are expected to be fairly the same for both. That gives V_{TH1}=V_{TH2}, and the C's only be different through dimensional parameters of length and width by design. It is straightforward for those skilled in the art to conclude that the current I_{D1} SO delivered in a drive cycle is given proportional to the input current I_{W} by
I_{D1}/I_{W}=C₁/C₂=W₁L₂/W₂L₁ (5)
or
I_{D1}∝I_{W}.

The drive method and pixel circuit provided herein thus provide a two-transistor solution to operate light emitting device displays in current control mode using all n-channel drive transistors pixel circuit in common-cathode structure, and without being influenced by the variation in characteristics of its circuit elements such as the threshold voltage of transistors. The ratios of dimensional parameters in Eq. (5) are constant by design, and remain constant to the first order of process variation, thereby providing a transfer function that is not impacted by geometry change due to non-uniformity in processing. It should be noted that the linearity between the input and output is a preferred transfer characteristics, but not a necessary condition for this invention to operate. It should also be noted that the ratio C₁/C₂ is not necessarily the same for all current levels. A slightly higher C₁/C₂ at lower current I_{W} than at higher I_{W} is typical. This is due to the condition of a constant total voltage across the light emitting element 805 and transistor 801, resulting in an increase in drain-to-source voltage drop V_{DS1} on drive transistor 801 from V_{DS2} that set V_{C}. Such a deviation is more at lower I_{W} than at higher I_{W}, and thus pushing 801 deeper into saturation from the onset point at lower current I_{W}. For transistors exhibit incomplete saturation, this shift of V_{DS} causes an increase in C₁, and a deviation of the ratio C₁/C₂. To the first order of operation, this deviation may be neglected; for more accurate image reproduction, this deviation may be compensated in input I_{W}, or with additional offset elements.

According to embodiment of FIG. 8 and its preferred operation, during the scanning period where a scanning signal is applied to the scan-power electrode, a data setting transistor 802 converts a data current directed from the data electrode to the scan electrode via 802 to a data voltage at one (the first) end of the capacitor 804 according to the transistor characteristic of 802 in its saturation condition. This data voltage is provided at the first end of the capacitor 804, while the second end of capacitor 804 is set to the same voltage as the voltage on the scan-power electrode via transistor 801.

The embodiment of FIG. 8 also provides a data setting circuit comprising the diode 809 arranged in series with second terminal and the third terminal of transistor 802, and wherein said data circuit connects the data electrode and the scan electrode 810 with a direct current path that conducts a data current from the data electrode to the scan electrode when the voltage of the scan electrode is set negative relative to the data electrode.

As described hereinabove, the preferred embodiment in FIG. 8 further provides, as a first additional perspective, an illustration of a direct current path (P1-P2-P3-P4) connecting said scan-power electrode as a first access electrode and said data electrode as a second access electrode, via A-terminal and B-terminal of transistor 802 and the diode 809. Such a current path conducts a current equal to the data current in a scanning cycle. The scanning cycle is controlled by applying a scanning voltage to the scan-power electrode.

It should be noted that various electrical elements may be further inserted or divided in such a current path to further modify the operation. These further modifications shall be construed as not violating the provision of a current path between a scan-power electrode and a data electrode to incorporate a drive function into the same scan-power electrode, as described in the present invention.

The preferred embodiment of FIG. 8 provides, as a second perspective, a demonstration of the configuration of terminals A and B of transistor 802 operating as drain and source varying in different operating cycles. The configuration of A and B terminals as being drain or source is not statically fixed at the time of implementing a pixel circuit, but rather alternates on the operation voltage applied on said scan-power electrode. In this respect, it is more appropriate to refer to these terminals as second and third terminals (in addition to the gate terminal) in this description and in the claims.

The preferred embodiment of FIG. 8 further provides, as a third perspective, a data setting circuit as provided in FIG. 6, comprising transistor 802 and diode 809, which converts input signal in a current form to a voltage form, and deliver such data voltage to the storage capacitor 804. Such data setting circuit comprises a direct current path connecting the scan-power electrode and data electrode is provided via said diode and said source and drain terminals of transistor 802 of such data setting circuit. A data current is directed from the data electrode to the scan-power electrode via such direct current path during a data setting (scan) period.

As another feature of this preferred embodiment, said data setting circuit comprises a data setting transistor 802, wherein a data voltage is generated at the gate (P2) which is in common with the source (P3) of transistor 802, while passing a data current from the data electrode to the scan electrode via transistor 802. Said data voltage sets the voltage of the capacitor 804.

During the period when a drive voltage (V_{HI}) is applied to the scan electrode, all paths leading to the storage element 804 are inhibited, thereby isolating the first end (connected to the gate of 801) of capacitor (and the gate of transistor 801) from any external influence.

The embodiment of FIG. 8 further demonstrates a pixel circuit for a light emitting device matrix operable in pixel-independent current control drive scheme, achievable in less than three transistors per pixel.

An active matrix display may be constructed from the pixel unit provided in this embodiment by forming such pixels at intersects between a plurality of data electrodes and a plurality of scan-power electrodes. As an example for a complete display unit, a current driver unit with matching number of output terminals is attached to the edge of such matrix display where each data electrode is connected to an output terminal of the data driver unit to provide data current signal. A scan-power driver is attached to another edge of such display matrix where each scan-power electrode is connected to an output terminal of the scan-power driver unit to receive scanning pulses and driver current.

The preferred embodiment of FIG. 8 provides a configuration wherein the cathodes of the light emitting device 805 is connected to a common reference voltage source VREF in the same manner for each and every pixel in an array. This preferred embodiment thus demonstrates a common cathode light emitting device display with an n-channel drive transistor operated in current control drive scheme.

In a preferred implementation of the above embodiment of FIG. 6, the transistors are thin film transistors (TFT) formed on a layer of amorphous or polycrystalline silicon on a transparent glass substrate. The transistors may also be form on single crystal silicon substrate, and may be either MOS or bipolar device. The common reference voltage source is typically supplied through a continuous layer of conductive material connecting each and every pixel. The organic light emitting diode may be formed with a stack of layers of small-molecule or polymer organic materials. Such light emitting structure typically comprises a cathode layer, an electron-transport layer, a hole-transport layer, and an anode layer. An additional emitter layer is often provided between the electron-transport and the hole-transport layers to enhance the light producing efficiency. The data and scan-power electrodes are typically formed by first depositing or coating a layer or layers of conductive materials, and followed by a standard photolithography and etch processing techniques to define the pattern of such electrodes. In a preferred implementation, the storage element is a parallel-plate capacitor formed by sequentially preparing a first conduct layer, an insulating layer, and a second conductive layer, followed by a standard photolithography and etch processing to define a capacitor structure. A preferred method typically used to connect various device structures in a display circuit, such as the one presented in FIG. 6 of this invention, is by defining the device pattern and contact points with a photolithography and etch process. Various techniques used to produce the structures and connections needed for the implementation of the circuit in FIG. 6 are available in the art, and the examples of which are found in the documents incorporated by reference.

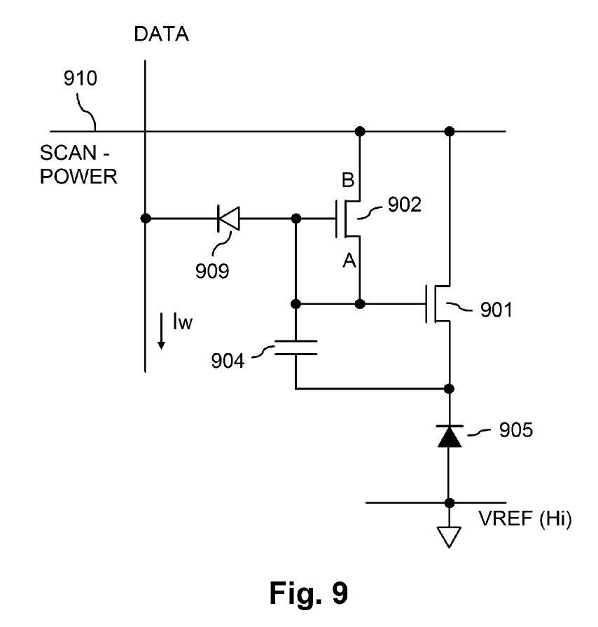

The pixel circuit provided in the embodiment of FIG. 8 works equally well for a pair of p-channel transistors. A preferred embodiment of p-channel implementation is provided in FIG. 9, wherein 901 and 902 are p-channel transistors, 909 is a diode, 905 is a light emitting device, and 904 is a storage capacitor, and wherein the polarity of the diodes, supply voltages, and scanning voltage levels are reversed.

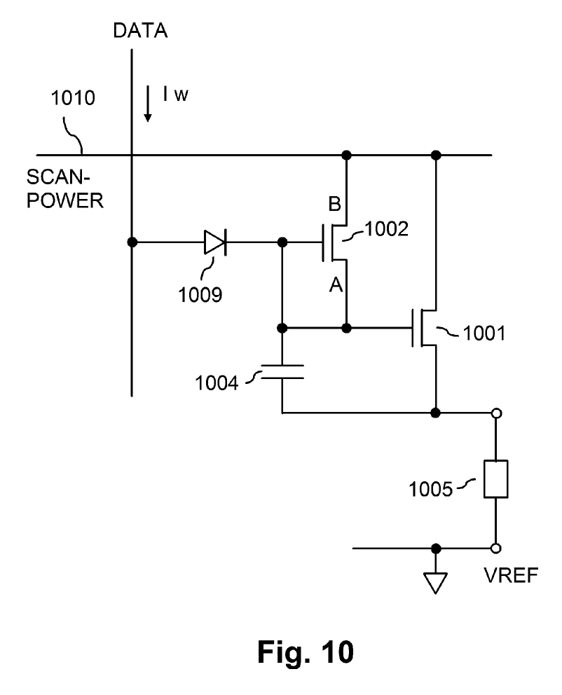

The pixel circuit provided in FIG. 8 may be extended to a broader application. Considering another preferred operating condition where the dynamic range of data input is set to well within the onset voltage of a light emitting device. Under this operating condition, and adopting the aforementioned compromised operation method, VREF is allowed to be set to the same level as V_{LO}. For example, consider an organic light emitting device having an onset voltage of 6.5V. By configuring the external data driver circuit to deliver data current in a dynamic range of 3.5V, that is well within the 6.5V onset voltage, will allow the pixel circuit to operate with VREF=V_{LO}. With such setting, VREF and the scanning electrode are at the same voltage level during a scanning cycle, thereby allowing 805 to be replaced by any type of light emitting device, including a bidirectional light emitting device. This extension is provided in FIG. 10, wherein transistors 1001 and 1002 may be all n-channel or all p-channel, the diode 1009 may reverse its polarity along with the change of transistors, 1004 is a storage element, and 1005 is a light emitting device.

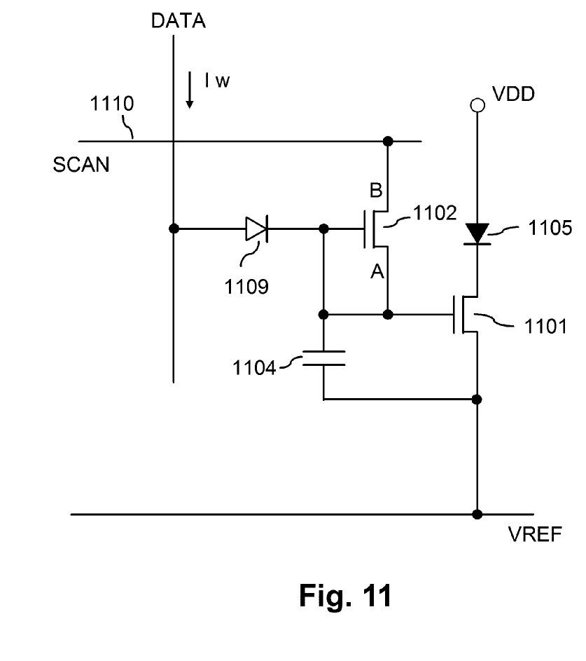

FIG. 11 provides another preferred embodiment of the present invention where the scan electrode operates separately from a power source that supplies the drive current. This embodiment comprises a voltage source VDD for delivering drive current, and a scan electrode for selecting a pixie for data input. To operate such pixel, the reference voltage VREF is switched in synchronous with the scan electrode. For a preferred operation, switching reference voltage source VREF is connected to the drive transistor 1101. In a preferred embodiment with n-channel drive transistor, FIG. 11 is implemented with two n-channel transistors 1101 and 1102, a diode 1109, a capacitor 1104, and a light emitting device 1105. In operation, during a data setting period when a scanning signal is applied to the scan electrode, VREF is set to the same voltage as the scan electrode, i.e. the scan signal. Data setting operation under such condition is thus identical to the operation of FIG. 8 as the second end of the capacitor is set to the same voltage of the scan electrode. In a drive period where it is necessary to isolate capacitor 1104, VREF is set to a voltage high V_{HI}. V_{HI} is so determined that V_{HI} sets the diode 1109 in reverse bias. To ensure such a condition, V_{HI} is set to be higher than the maximum data voltage. The rules for setting such V_{HI} follow the same principles as described in the discussion for FIG. 8. The operation of FIG. 11 makes no reliance on the polarity of the light emitting device 1105. Thus the light emitting device may be a diode, or a bi-directional device. The reverse configuration may be obtained similarly as that for FIG. 9.

It is also illustrated in FIG. 11 that the inclusion of a functional circuit block of 700 is a preferred addition to the data setting circuit 600 to perform and to delivered the merits of the best mode of operation as illustrated and described in a preferred embodiment in FIG. 8. FIG. 11 comprises the circuit block of FIG. 6, while the functional feature of FIG. 7 is achieved by simultaneously switching of VREF in synchronous with the signal on the scan electrode. As a whole, FIG. 11 delivers a similar merit as that of the embodiment of FIG. 8.

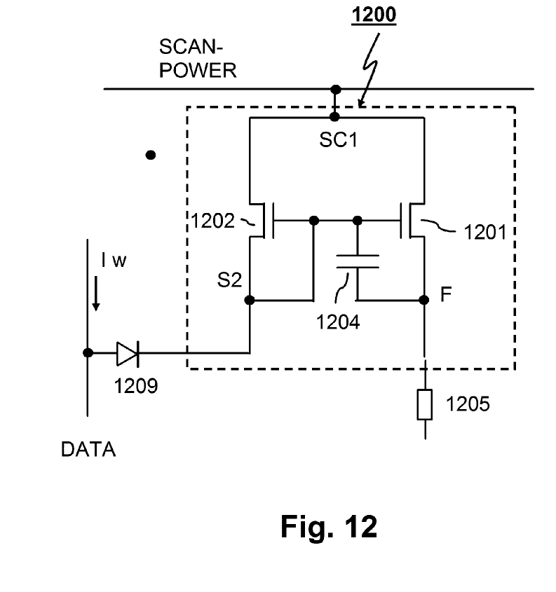

Furthermore, as illustrated in the preferred embodiments of FIG. 8 and 9, the present invention provides a circuit block 1200 of FIG. 12 in a pixel. Circuit unit 1200 is obtained by re-grouping circuit elements of FIG. 8 and FIG. 9, wherein 1200 comprises a first transistor 1201, a second transistor 1202, and a capacitor 1204. One (the first) end of capacitor 1204 is connected in common with the gate of transistor 1201, the gate of transistor 1202, and the second end S2 of transistor 1202; this common node S2 is referred to as the data input end. In preferred embodiments of FIG. 8 and 9, this data input end is connected to the data electrode via a diode 1209, as illustrate in the respective figures via the cathode and anode of the diode 1209. The other (second) end of capacitor 1204 is connected to a source-drain (a second) terminal of transistor 1201 at a node F, the drive output end. In a preferred embodiment, FIG. 8 for example, a light emitting element 1205 is connected to node F in common with the second end of 1204 and the second terminal of 1201. The third terminals of transistor 1201 and 1202 are connected in common at SC1, the pixel select end. In a preferred embodiment, FIG. 8 for example, the pixel selected end SC1 is connected to a scan electrode. In FIG. 12, the transistor 1201 corresponds to the transistors 801 and 901 in the respective preferred embodiments of FIG. 8 and 9; transistor 1202 corresponds to the transistors 802 and 902 in the respective preferred embodiments of FIG. 8 and 10. Circuit block 1200 is a re-orientation of corresponding circuit blocks in the respective embodiments in FIG. 8 and 9. As described above for the embodiment of FIG. 8, the circuit 1200 is operated by applying a first signal and a second to the scan-power electrode connected to SCI. The first signal sets diode 1209 in forward bias, turns on transistor 1202 making S2 a drain terminal of 1202, and generates a data voltage at S2 from a data current directed from S2 to SC1. The second signal set diode 1209 in reverse bias, reverses the source and drain of transistor 1202, making S2 a source terminal of 1202 and turning off transistor 1202, thereby isolating the first end (connected to the gate of 1201) of capacitor 1204. The circuit 1200 provided in FIG. 12 may be operated in combination with a diode as illustrated herein, or with other circuit elements such as a transistor. The preferred embodiment 1200 thus further provides a derived and extended scope and flexibility of operation.

Various light emitting devices may be incorporated to form an array of display elements or light source, such as that used for LCD backlight. These light emitting devices include such structures and materials as silicon and GaN LEDs, or white LEDs. Such light emitting devices and systems may readily adopt the principles and methods of the present invention, or to include the circuit directly derived from this invention. Such combinations are conceivably within the scope of the present invention, and the present invention embraces all such applications. It is also conceivable that various types of materials may be used to construct active elements for the circuit, and all such variations are embraced by the present invention.

A circuit in a pixel comprising the basic structure of 600, or further incorporating circuit elements inserted between or connected to elements of 600, with or without additional elements attached, is conceivably within the spirit and scope of the present invention. A use of such feature to form a current path between an electrode carrying a scanning function (scan-power electrode or a conventional scanning electrode) and said data electrode, with or without additional current path is also well within the spirit and scope of the present invention. Furthermore, as commonly practiced in the art, inserting resistors or capacitors at various nodes in the circuit provided hereinbefore to pre-condition a signal, modify its transient property, or provide fine adjustment of voltage while leaving the basic circuit operation the same as discussed in this disclosure falls well within the scope of the present invention.

Although various embodiments utilizing the principles of the present invention have been shown and described in detail herein, those skilled in the art can readily devise many other variances, modifications, and extensions that still incorporate the principles disclosed in the present invention. The scope of the present invention embraces all such variances, and shall not be construed as limited by the number of active elements, wiring options of such, or the polarity of a light emitting device.

What is claimed is:

1. A device comprising at least
a pixel;
a data electrode to deliver data information to said pixel;
a scan electrode to select said pixel to receive said data information; wherein said scan electrode operates at least with a first signal to select said pixel to receive said data information during a data setting period;
wherein said pixel comprises a data setting circuit connecting said data electrode and said scan electrode;
wherein said data setting circuit comprises:
a data setting active element comprising a gate, a second terminal and a third terminal;
wherein said data setting circuit further comprises
a diode comprising an anode and a cathode;
wherein said second terminal and said third terminal of said data setting active element are arranged in series with said diode; and
wherein said data setting circuit provides a direct current path between said data electrode and said scan electrode via said diode in forward bias, and said second terminal and said third terminal of said data setting active element during said data setting period.

2. The device according to claim 1, wherein said data setting circuit generates a data voltage at said second terminal of said data setting active element during said data setting period.

3. The device according to claim 2, wherein said data setting circuit further generates same said data voltage at said gate of said data setting active element.

4. The display according to claim 1, wherein said data setting circuit generates a data voltage at said gate of said data setting active element during said data setting period.

5. The device according to claim 4, wherein said data setting circuit directs a data current from said data electrode to said scan electrode via said diode and said data setting active element during a data setting period;
wherein said data setting circuit converts said data current to said data voltage at said gate of said data setting active element.

6. The device according to claim 1, wherein said gate and said second terminal of said data setting active element are connected in common;
and wherein a data current is directed from said data electrode to said scan electrode during a data setting period;
wherein a data voltage is generated at said gate of said data setting transistor according to said data current.

7. The device according to claim 1, wherein said pixel further comprises
a storage element comprising a first end and a second end;
a drive active element comprising a gate, a second terminal and a third terminal;
a light emitting element comprising a first end and a second end;
a reference voltage source;
wherein said data setting circuit sets said first end of said storage element to said data voltage during said data setting period.

8. The device according to claim 7, wherein said first end of said storage element, said gate of said data setting active element, and said gate of said drive active element are connected in common.

9. The display according to claim 7, wherein said pixel further comprises a second direct current path connecting said scan electrode and said reference voltage source via said drive active element and said light emitting element;
wherein said scan electrode further operates with a second signal, during which said scan electrode delivers a drive current to said light emitting element via said second direct current path;
wherein said drive active element regulates said drive current according to said data voltage set to said storage element.

10. The device according to claim 7, wherein said light emitting element and said drive active element are connected in series to form a conducting path between said scan electrode and said reference voltage source via said light emitting element and said second terminal and said third terminal of said drive active element;
wherein said second terminal of said drive active element is connected to said second end of said storage element, and to said light emitting element;
wherein said gate of said drive active element is connected to said first end of said storage element, to said gate of said data setting active element, to said second terminal of said data setting active element, and to said diode.

11. The device according to claim 1 comprising in further detail:
a pixel; a data electrode for delivering data information to said pixel; a scan electrode for selecting said pixel to receive said data information in a data setting period;
said pixel comprising:
a light emitting device comprising a first end and a second end;
a storage element comprising a first end and a second end;
a drive transistor comprising a gate, a second terminal and a third terminal;
said drive transistor regulates a current directed to said light emitting element; a reference voltage source;
a data setting circuit comprising:
a diode comprising a first end and a second end;
a data setting transistor comprising a gate, a second terminal, and a third terminal;
wherein the pixel circuit is connected in the following manner:
said data electrode being connected to said scan electrode via said first end of said diode, said second end of said diode, said second terminal of said data setting transistor, and said third terminal of said data setting transistor.

12. The device according to claim 11, wherein said pixel circuit is connected in further detail as follows:
said scan electrode is connected to said reference voltage source via said light emitting element, said second terminal of said drive transistor, and said third terminal of said drive transistor.

13. The device according to claim 12 wherein said second end of said storage element is connected to said second end of said drive transistor.

14. A device comprising at least:
a pixel;
a data electrode to deliver data information to said pixel;
a scan electrode to select said pixel to receive said data information; wherein
said scan electrode operates with at least a first signal and a second signal; wherein said scan electrode operates with said first signal to select said pixel to receive said data information during a data setting period;
wherein said pixel comprises at least:
a storage element having a first end and a second end;
a data setting circuit connecting said data electrode and said scan electrode;
wherein said data setting circuit comprises:
a data setting active element having a gate, a second terminal and a third terminal;
wherein said data setting circuit conducts a data current from said data electrode to said scan electrode via said second terminal and said third terminal of said data setting active element during said data setting period;
wherein said data setting circuit generates a data voltage at said gate of said data setting active element from said data current;
wherein said data setting circuit further comprises
a diode having a first and a second terminals,
wherein said data setting circuit conducts said data current via said diode in forward bias during said data setting period.

15. The device according to claim 14, wherein said data setting circuit sets said first end of said storage element to said data voltage during said data setting period.

16. The device according to claim 15, wherein said diode operates in reverse bias during the period when said scan electrode operates with said second signal;
wherein said diode in reverse bias inhibits said data current from entering said pixel from said data electrode during the period when said scan electrode operates with said second signal.

17. The device according to claim 15, wherein said data setting active element operates in an off-state during the time when said scan electrode operates with said second signal, isolating said first end of said storage element from said scan electrode.

18. The device according to claim 15, wherein said data setting circuit generates said data voltage at said gate of said data setting active element and at said second terminal of said data setting active element.

19. The device according to claim 15, wherein said pixel further comprises
a drive transistor comprising a gate, a second terminal and a third terminal; a light emitting element comprises a first end and a second end;
wherein the gate of said drive transistor is connected to said first end of said storage element;
wherein said drive transistor regulates a drive current directed to said light emitting element via said drive transistor according to said data voltage set in said storage element.

20. The device according to claim 19, wherein said drive transistor provides a conducting path between the second end of said storage element and said scan electrode during said data setting period, setting the two at the same voltage.

21. The method to operate the device according to claim 9, wherein said method comprises:
applying a first signal to set said data voltage to said storage element, applying a second signal to enable a drive current delivered from said scan electrode to said light emitting element;
wherein said second signal is set to induce such a voltage at the point where said storage element is connected to said second terminal of said drive active element that, adding any said data voltage across said storage element, is sufficient to set said diode in reverse bias.

22. The method to operate the device according to claim 14, said method comprising steps of:
applying said first signal to said scan electrode during a data setting period to set said diode in forward bias and to direct a data current delivered from said data electrode to said scan electrode;
wherein said first signal is set to ensure said diode being in forward bias for all data voltage within the operation voltage range;
applying a second signal to said scan electrode to terminate data current directed to said pixel from said data electrode; wherein said second signal voltage is set to ensure that said diode is in reverse bias, and wherein said data setting active element is in off-state.

23. The method according to claim 22,
wherein said first signal sets a configuration to said data setting active element where said second terminal of said data setting active element operates as a drain;
wherein said second signal sets a configuration to said data setting active element where said second terminal of said data setting active element operates as a source.

24. The method to operate the device according to claim 19, said method comprising steps of:
applying said first signal to said scan electrode during a data setting period to set said diode in forward bias and to direct a data current delivered from said data electrode to said scan electrode; wherein said first signal is set to ensure said diode being in forward bias for all data voltage within the operation range;
applying a second signal to said scan electrode to terminate data current directed to said pixel from said data electrode; wherein said second signal voltage is set to ensure that said diode is in reverse bias, and wherein said data setting active element is in off-state;
wherein said second signal enables a drive current via said drive transistor to said light emitting element.

25. The method to operate the device according to claim 20, said method comprising:
applying said first signal to said scan electrode during a data setting period to set said diode in forward bias and to direct a data current delivered from said data electrode to said scan electrode; wherein said first signal is set to ensure said diode being in forward bias for all data voltage within the operation range;
wherein said first signal is set to equalize the potential on both second terminal and said third terminal of said drive transistor, wherein said second signal sets the second end of said storage element to the same voltage of said scan electrode.

26. A display device comprising at least a pixel, said pixel comprising a control circuit having a data input end, a drive output end, and a pixel select end; wherein said control circuit comprises:
a first transistor comprising a gate terminal, a second terminal, and a third terminal;
a second transistor comprising a gate terminal, a second terminal, and a third terminal;
a storage element having a first end and a second end;
wherein said gate of said first transistor, said gate of said second transistor, said second terminal of said second transistor, said first end of said storage element are connected in common with said data input end;
wherein said second end of said storage element, said second terminal of said first transistor are connected in common with said drive output end;
wherein said third terminals of said first transistor and said second transistor are connected in common with said pixel select end.

27. The display device according to claim 26, wherein said pixel further comprise:
a diode;
a data electrode for delivering data information to said pixel; wherein said data electrode is connected to said data input end via said diode.
